(19) United States
(12) Patent Application Publication
(10) Pub. No.: US 2024/0176617 A1
(43) Pub. Date: May 30, 2024

(54) VECTOR REDUCE INSTRUCTION

(71) Applicant: INTERNATIONAL BUSINESS MACHINES CORPORATION, Armonk, NY (US)

(72) Inventor: Charles E. HACKETT, Greenlawn, NY (US)

(21) Appl. No.: 18/059,119

(22) Filed: Nov. 28, 2022

(51) Int. Cl. G06F 9/30

(52) U.S. Cl. CPC G06F 9/30036; G06F 9/30101

(57) ABSTRACT

An instruction that includes an operation code indicating a reduce instruction is obtained and executed within a computing environment. The executing includes selecting a field of a source operand stored in a source location. The source location is designated using the instruction and the field includes a plurality of bits. An operation is performed on the plurality of bits of the field to obtain a result. The result reduces the plurality of bits to a set of bits. The set of bits includes one or more bits and has fewer bits than the plurality of bits. The result is placed in a target location specified using the instruction.

### BACKGROUND

One or more aspects relate, in general, to facilitating processing within a computing environment, and in particular, to improving instruction processing within the computing environment.

Different classes of instructions may be supported by a computing environment including, but not limited to, single instruction/multiple data (SIMD) or vector instructions that enable parallel processing of data sets. A single vector instruction processes multiple data in parallel.

Instructions executed within a computing environment, including vector instructions, perform operations defined by the instructions. Many types of operations may be performed ranging from simple operations to complex operations. Based on performing certain operations, results are provided that are used by other instructions. Therefore, it is beneficial to optimize the results to facilitate further processing by the other instructions.

### SUMMARY

Shortcomings of the prior art are overcome, and additional advantages are provided through the provision of a computer program product for facilitating processing within a computing environment. The computer program product includes one or more computer readable storage media and program instructions collectively stored on the one or more computer readable storage media to perform a method. The method includes obtaining an instruction to be executed within a computing environment. The instruction includes an operation code indicating a reduce instruction. The instruction is executed, and the executing includes selecting a field of a source operand stored in a source location. The source location is designated using the instruction and the field includes a plurality of bits. An operation is performed on the plurality of bits of the field to obtain a result. The result reduces the plurality of bits to a set of bits. The set of bits includes one or more bits and has fewer bits than the plurality of bits. The result is placed in a target location specified using the instruction.

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present invention;

FIG. 2 depicts one example of further details of a processor of the processor set of FIG. 1, in accordance with one or more aspects of the present invention;

FIG. 3A depicts one example of sub-modules of a vector reduce module of FIG. 1, in accordance with one or more aspects of the present invention;

FIG. 3B depicts one example of sub-modules of the execute instruction sub-module of FIG. 3A, in accordance with one or more aspects of the present invention;

FIG. 4 depicts one example of a format of a Vector Reduce instruction, in accordance with one or more aspects of the present invention;

FIG. 5A depicts one example of vector reduce instruction processing, in accordance with one or more aspects of the present invention;

FIG. 5B depicts one example of perform operation processing of the vector reduce instruction processing of FIG. 5A, in accordance with one or more aspects of the present invention; and

FIGS. 6A-6B depict another example of a computing environment to incorporate and use one or more aspects of the present invention.

### DETAILED DESCRIPTION

In accordance with one or more aspects of the present invention, a capability is provided to facilitate processing within a computing environment. In one aspect, the capability includes an instruction to optimize data within each field of one or more fields of a source operand stored in a source location designated using the instruction. As an example, the data is a result of a previous instruction, and the data is stored in the one or more fields. The optimization includes, for instance, reducing the data within a field from one size to another size. As an example, each n bits (e.g., eight bits, sixteen bits, thirty-two bits, sixty-four bits, etc.) of a field of the source operand is reduced to n′ bits (e.g., one bit) that represents or summarizes the n bits of the data based on an operation performed on the data. For instance, if the operation is a logical AND operation and each bit within a field of the source operand (e.g., each bit of eight bits, where the size of the field is eight bits) is set to binary 1, then the result is one bit set to a binary 1. Thus, a plurality of bits (e.g., eight bits) of a single field is reduced to a set of bits having fewer bits than the plurality of bits (e.g., one bit). Similarly, if the operation is a logical OR, and at least one bit of the field is a binary 1, the result is one bit set to a binary 1. Other examples are also possible.

In one example, the source location is a vector register (or multiple vector registers) that stores a vector (source operand) having one or more fields (e.g., one to sixteen fixed-size fields), which are referred to as elements within the vector. Thus, in one example, the instruction is a vector instruction, referred to herein as a vector reduce instruction. Although in one example the source location is at least one vector register and the instruction is a vector instruction, in other embodiments, the source location is another register (e.g., a general purpose register) or other location, and the instruction is other than a vector instruction. Other examples are possible.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., performs data reduction (e.g., vector data reduction) and/or one or more other aspects of the present invention. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

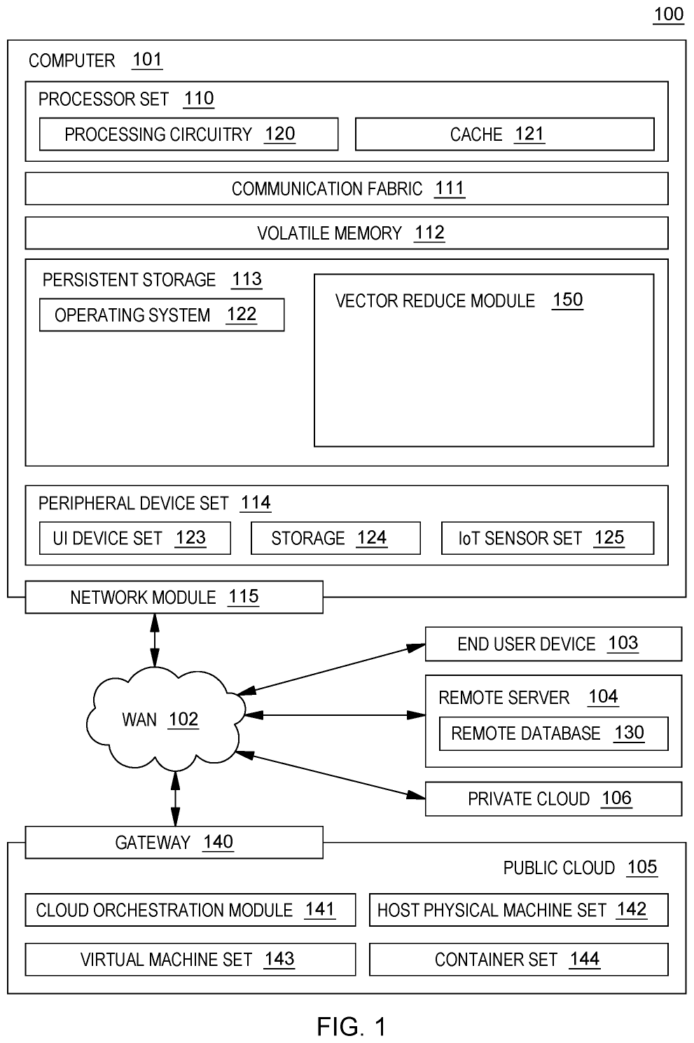

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as vector reduce code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

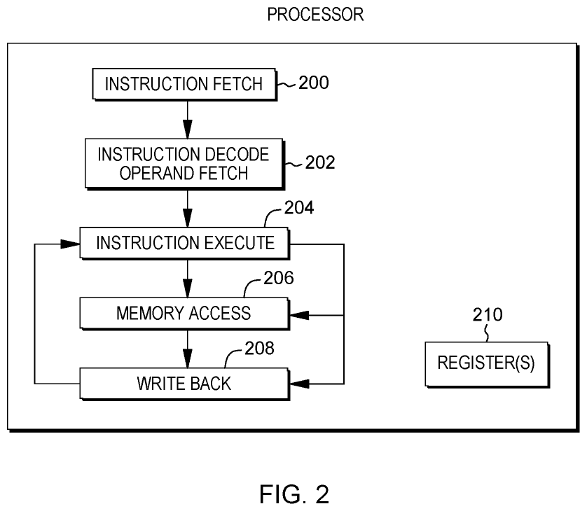

In one example, a processor (e.g., of processor set 110) includes a plurality of functional components (or a subset thereof) used to execute instructions. As depicted in FIG. 2, in one example, these functional components include, for instance, an instruction fetch component 200 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use vector reduce module 150. Additionally, fewer and/or other components may be used in one or more aspects of the present invention.

In one example, a vector reduce module (e.g., vector reduce module 150) is used, in accordance with one or more aspects of the present invention. A vector reduce module (e.g., vector reduce module 150) includes code or instructions used to perform vector reduce processing, in accordance with one or more aspects of the present invention. A vector reduce module (e.g., vector reduce module 150) includes, in one example, various sub-modules to be used to perform the processing. The sub-modules are, e.g., computer readable program code (e.g., instructions) in computer readable media, e.g., storage (storage 124, persistent storage 113, cache 121, other storage, as examples). The computer readable media may be part of a computer program product and may be executed by and/or using one or more computers, such as computer(s) 101; servers, such as remote server(s) 104; processors, such as a processor of processor set 110; and/or processing circuitry, such as processing circuitry 120 of processor set 110; etc. Additional and/or other computers, servers, processors, and/or processing circuitry may be used to execute one or more of the sub-modules and/or portions thereof. Many examples are possible.

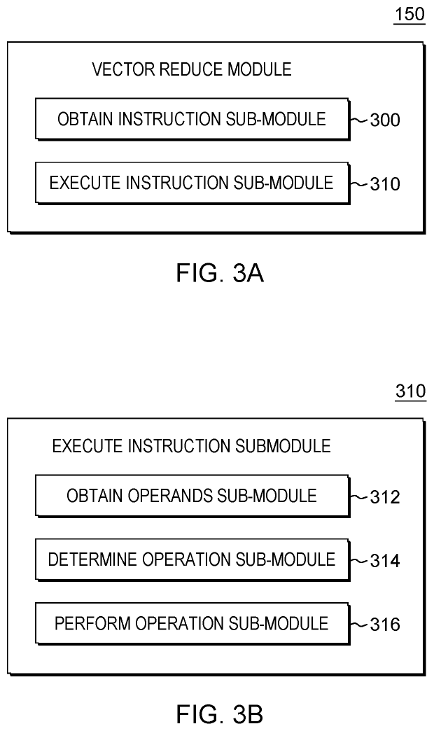

One example of vector reduce module 150 is described with reference to FIG. 3A. In one example, vector reduce module 150 includes an obtain instruction sub-module 300 to obtain (e.g., receive, be provided, pull, retrieve, fetch, etc.) a vector reduce instruction to be executed, and an execute instruction sub-module 310 to be used to execute the vector reduce instruction.

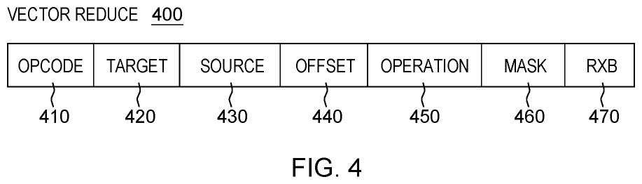

In one example, referring to FIG. 3B, execute instruction sub-module 310 includes, for instance, an obtain operands sub-module 312 to obtain one or more operands of the vector reduce instruction; a determine operation sub-module 314 to determine the operation to be performed by the vector reduce instruction; and a perform operation sub-module 316 to perform the determined operation. Further details relating to a vector reduce instruction are described with reference to FIG. 4.

In one embodiment, a vector reduce instruction, such as a Vector Reduce instruction 400, is a single architected hardware machine instruction at the hardware/software interface. As an example, it is part of an instruction set architecture. One example of an instruction set architecture to incorporate and/or use a vector reduce instruction and/or aspects of the present invention is the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-12, Thirteenth Edition, September 2019, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present invention. z/Architecture and IBM are trademarks or registered trademarks of International Business Machines Corporation in at least one jurisdiction.

In one example, the Vector Reduce instruction is part of a vector facility of an instruction set architecture. The vector facility provides, for instance, fixed sized vectors ranging from, e.g., one to sixteen elements (also referred to as fields herein). Each vector includes data which is operated on by vector instructions defined in the facility. In one embodiment, if a vector is made up of multiple elements, then each element is processed in parallel with the other elements. Instruction completion does not occur, in one example, until processing of all the elements is complete. In other embodiments, the elements are processed partially in parallel and/or sequentially; and/or there may be additional elements.

In one embodiment, there is a plurality of vector registers and other types of registers can map to a quadrant of the vector registers. For instance, a register file, which is an array of processor registers in a central processing unit (e.g., a processor of processor set 110), may include, e.g., 32 vector registers and each register is 128 bits in length. Sixteen floating-point registers, which are 64 bits in length, can overlay the vector registers. Thus, as an example, when floating-point register 2 is modified, then vector register 2 is also modified. Other mappings for other types of registers are also possible.

Vector data appears in storage in the same left-to-right sequence, for instance, as other data formats. Bits of a data format that are numbered 0-7 constitute the byte in the leftmost (lowest-numbered) byte location in storage, bits 8-15 form the byte in the next sequential location, and so on. In a further example, the vector data may appear in storage in another sequence, such as right-to-left.

Continuing with FIG. 4, Vector Reduce instruction 400 includes a plurality of fields, including one or more operation code (opcode) fields 410 that indicate that this is a vector reduce instruction. Although in FIG. 4 there is one opcode field 410 depicted, in other examples, there may be multiple opcode fields. For instance, there may be one opcode field at the beginning of the instruction format and another at the end of the instruction format. Other examples are also possible.

Further, in one example, Vector Reduce instruction 400 includes a target field 420 used to designate a target location (e.g., one or more general purpose registers; one or more vector registers; etc.) to store the result of vector reduce processing; a source field 430 used to designate a source location (e.g., one or more vector registers) as an input to the instruction; an offset field 440 used to indicate an offset into the target location, such as a number of bits from, e.g., a leftmost position (or rightmost position or other position) in the target location; an operation field 450 used to indicate a logical operation to be performed (e.g., AND, OR, XOR, NAND, NOR, XNOR, etc.); a mask field 460 used to indicate a size of one or more fields of a source operand stored in the source location; and a register extension bit (RXB) field 470 to be used, in one example, with the source field to designate the source location (e.g., vector register(s)) used by the instruction, as described below.

In one particular example, Vector Reduce instruction 400 has a format, referred to as a vector register to register operand with an extended opcode format, having, e.g., 48 bits. In this particular example, Vector Reduce instruction 400 has multiple operation code fields 410 (e.g., bits 0-7 and 40-47); target field 420 (also referred to as R₁ specifying at least one general purpose register) is in, e.g., bits 8-11; source field 430 (also referred to as V₂ specifying at least one vector register) is in, e.g., bits 12-15; offset field 440 (also referred to as I₃ specifying an immediate field in which the value within the immediate field is the offset into the target location, or D₂ (B₂) specifying a displacement (D₂) value which is added to a value in a base register (B₂) to provide the offset) is in, e.g., bits 16-23; operation field 450 (also referred to as 14) is in, e.g., bits 28-31; mask field 460 (also referred to as M₅) is in, e.g., bits 32-35; and register extension bit (RXB) field 470 is in, e.g., bits 36-39. In one embodiment, the fields of the instruction are separate and independent from one another; however, in other embodiments, more than one field may be combined. Further, although example types of registers are specified for the source field and the target field, other types of registers may be used. For instance, the target field may specify one or more vector registers or other types of registers. Similarly, the source field, in other embodiments, may specify other than vector registers. Other examples are possible.

If a field has a subscript number associated therewith, the subscript number associated with the field denotes the operand to which the field applies. For instance, subscript number 1 associated with register R₁ denotes that the register(s) specified using R₁ includes the first operand, subscript number 2 associated with vector register V₂ denotes that the register(s) specified using V₂ includes the second operand, and so forth.

In one example, register extension bit (RXB) field 470 includes the most significant bit for a vector register designated operand. Bits for register designations not specified by the instruction are to be reserved and set to zero. The most significant bit is concatenated, for instance, to the left of a four-bit register designation of the vector register field (e.g., V₂) to create a five-bit vector register designation.

In one example, the RXB field includes four bits (e.g., bits 0-3), and the bits are defined, as follows:
0—Most significant bit for a first operand vector register designation (e.g., in bits 8-11) of the instruction, if any.
1—Most significant bit for a second operand vector register designation (e.g., in bits 12-15) of the instruction, if any.
2—Most significant bit for a third operand vector register designation (e.g., in bits 16-19) of the instruction, if any.
3—Most significant bit for a fourth operand vector register designation (e.g., in bits 32-35) of the instruction, if any.

Each bit is set to zero or one by, for instance, the assembler depending on the register number. For instance, for registers 0-15, the bit is set to 0; for registers 16-31, the bit is set to 1, etc. Thus, a register containing the operand is specified using, for instance, a four-bit field of the register field with the addition of its corresponding register extension bit (RXB) as the most significant bit. For instance, if the four-bit field is 0110 and the extension bit is 0, then the five bit field 00110 indicates register number 6. In a further embodiment, the RXB field includes additional bits, and more than one bit is used as an extension for each vector or location. Further, in other embodiments, the assignment of RXB bits to operands and/or bits of the instruction format may be different than the example herein. Other variations are possible.

In the description herein of a vector reduce instruction, such as Vector Reduce instruction 400, specific locations, specific fields and/or specific sizes of the fields may be indicated (e.g., specific bytes and/or bits). However, other locations, fields and/or sizes may be provided. Further, although the setting of a bit to a particular value, e.g., one or zero, may be specified, this is only an example. The bit, if set, may be set to a different value, such as the opposite value or to another value, in other examples. Many variations are possible.

A vector reduce instruction, such as Vector Reduce instruction 400, may have additional, fewer and/or other fields. For instance, one or more fields of a vector reduce instruction, such as Vector Reduce instruction 400, may be optional. As examples, one or more of offset field 440, operation field 450, mask field 460 and/or RXB field 470 are optional. For instance, a vector reduce instruction, such as Vector Reduce instruction 400, may not have an offset field; instead, the instruction is configured to use the least significant bit or the most significant bit of the target register. In one or more examples, the operation is not specified in an operation field, instead, the instruction is configured to perform a specific operation, such as an AND operation or other operation. In one or more examples, the operation may be specified by the opcode. In one or more examples, a mask field is not used to specify the size, instead, a size of the elements of the source vector is implied. In a further example, the RXB field is not used, instead, the source register field includes an indication of the vector register. Many variations are possible.

As indicated, in one example, an operation field (e.g., operation field 450) is provided, such that one operation code may be used but a plurality of operations may be specified. For a particular invocation of the instruction, one of the plurality of operations is specified in the operation field. As examples, one or more bits of the operation field may be used to specify each of the different operations (AND, OR, XOR, NAND, NOR, XNOR, etc.); one or more bits may be used to specify each of the operations (AND, OR, XOR, etc.), excluding the NOT versions (NAND, NOR, XNOR, etc.), and a bit (or one or more bits) may be used to specify the NOT version; a mask may be used in which each operation (or selected operations, such as the operations except for the NOT versions) has a particular bit (or bits) associated therewith and when a bit has a selected value, such as binary 1, the corresponding operation is to be performed (if selected operations, an additional mask bit (or bits) may specify the NOT version—e.g., a mask has a plurality of bits including one for each selected operation (e.g., AND, OR, XOR, etc.) and another bit for NOT). Many variations are possible.

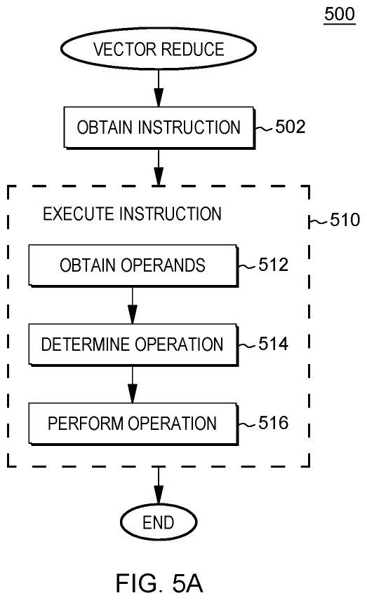

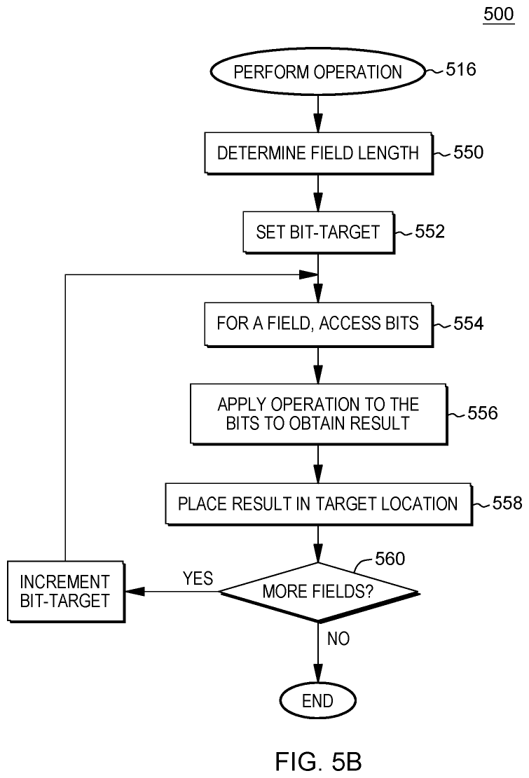

In accordance with one or more aspects of the present invention, vector reduce processing, including execution of a vector reduce instruction, such as Vector Reduce instruction 400, is facilitated using a vector reduce module (e.g., vector reduce module 150). Vector reduce module 150 includes one or more sub-modules (e.g., sub-modules 300 and 310-316) that are used in vector reduce processing, as further described with reference to FIGS. 5A-5B. In one example, a vector reduce process is executed by one or more of a computer (e.g., computer 101, other computer(s), etc.), a server (e.g., remote server 104, other server(s)), a processor and/or processing circuitry (e.g., of processor set 110 or other processor sets), etc. Although example computers, servers, processors and/or processing circuitry are provided, additional, fewer and/or other computers, servers, processors and/or processing circuitry may be used for the vector reduce process. Various options are possible.

Referring to FIG. 5A, in one example, a vector reduce process 500 obtains 502 (e.g., receives, retrieves, fetches, is provided, pulls, etc.) an instruction, such as Vector Reduce instruction 400, and executes 510 the instruction. Execution includes, for instance, obtaining 512 one or more operands of the instruction. As examples, process 500 obtains one or more of: an operation code from opcode field 410, an indication of a target location (e.g., a general purpose register, a vector register, etc.) from target field 420, a source operand from a source location (e.g., a register, such as, e.g., a vector register) designated using source field 430 and register extension bit field 470, an offset from offset field 440, an operation from operation field 450, and a size from mask field 460. The operands to be obtained depend, for instance, on which operands are specified using the instruction and/or are being used. As noted herein, some operands are optional and may not be used in various embodiments. Further, in one or more embodiments, additional, fewer and/or other operands may be used. Many variations are possible.

Based on obtaining the operands, in one example, process 500 determines 514 the operation to be performed (e.g., as specified, e.g., in operation field 450). Example operations include AND, OR, XOR, NAND, NOR and XNOR. Additional, fewer and/or other operations may be specified. Further, in other embodiments, an operation field is not specified, and instead, the operation is determined from another field of the instruction, such as one or more opcode fields (e.g., opcode field 410; opcode specified by a first set of selected bits of the instruction format (e.g., bits 0-7) and a second set of selected bits of the instruction (e.g., bits 40-47); or it is implied, etc.

In one example, based on determining the operation, process 500 performs 516 the operation. Further details relating to performing the operation are described with reference to FIG. 5B. As examples, the perform operation is executed by one or more of a computer (e.g., computer 101, other computer(s), etc.), a server (e.g., remote server 104, other server(s)), a processor and/or processing circuitry (e.g., of processor set 110 or other processor sets), etc. Although example computers, servers, processors and/or processing circuitry are provided, additional, fewer and/or other computers, servers, processors and/or processing circuitry may be used for the vector reduce process. Various options are possible.

In one example, to perform the operation, process 500 determines 550 a length of the fields of the source operand (e.g., the length of each element (field) of the vector stored in the vector register specified by the source field (e.g., source field 430) and the register extension bit field (e.g., RXB field 470)). As an example, a field length is obtained from mask field 460. In other examples, the field length is fixed and not specified in a field of the instruction; is provided by a different field of the instruction; or is implied or implicitly specified; etc. Various options are possible.

Further, in one example, process 500 sets 552 a variable, referred to herein as bit-target, to an initial value. For instance, it is set to the offset provided by, e.g., offset field 440. This is a position in the target location (e.g., register, such as a general purpose register, a vector register, etc.) to receive a result.

In one example, process 500 accesses 554 bits of a field of a vector stored in a vector register designated using the source field (e.g., source field 430) and the register extension bit field (e.g., RXB field 470). For instance, process 500 accesses bits of an element of the source vector. Process 500 applies 556 the operation to the bits of the field (element) to obtain a result. For instance, the operation (e.g., AND, OR, XOR, NAND, NOR, XNOR, etc.) is applied using horizontal logical reduction to each bit in the field to obtain a result. As an example, if a field (element) has eight bits (0-7), determined by the size indication specified using the instruction (e.g., mask field 460), and the operation is AND, the operation is performed as follows, where x is the AND operation (or other operation, as indicated by the instruction): bit 0×bit 1×bit 2×bit 3×bit 4×bit 5×bit 6×bit 7. The result is, for instance, one bit (e.g., a binary 1 or 0), depending on the operation and values of the bits in the field. As an example, if the operation is an AND operation and one of the bits is a 0 (e.g., binary 0), then the result is 0 (e.g., binary 0). Other examples are possible.

Process 500 places 558 the result in a target location. For instance, the result (e.g., the single bit resulting from the horizontal logical reduction of the bits of the field) is placed in the target location, e.g., the general purpose register (or vector register, etc.) specified by the target field (e.g., target field 420) at a position within the register specified by the bit-target.

Process 500 determines 560, in one example, whether there are more fields to be processed. This is determined, for instance, based on the number of fields to be processed and the number of fields already processed. The number of fields to be processed may be determined based on, for instance, the size of the source location (e.g., source vector register) and the field size provided using the instruction (e.g., in mask field 460). For example, if the designated source vector register is 128 bits in length and the field size is 8 bits, then there are 16 fields to be processed, as one example. Other techniques for determining the number of fields to be processed may be used. In one example, the number of fields already processed may be determined by a running count of the fields processed and/or other techniques.

Should there be one or more additional fields to be processed (e.g., the number of fields to be processed minus a count of the number of fields already processed is greater than 0), process 500 increments bit-target, e.g., by 1 (or another number), and process 500 continues with accessing 554 bits of the next field to be processed. However, if there are no more fields to be processed, then processing is complete, and the target location includes results of applying the operation to each of the fields (or selected fields) of the source operand.

In one embodiment, multiple fields of the vector register are processed in parallel, and therefore, the appropriate bit-target is determined for each of those fields to ensure that the result for each field is placed in the correct position within the target location. If there are one or more additional fields to be processed, the appropriate bit-target is determined for each of those additional fields to be processed to ensure proper placing of each of the results. Various techniques may be used to determine the correct positions (and bit-targets) in the target location for the result(s). In one embodiment, all the fields of the vector are processed in parallel.

In accordance with one or more aspects of the present invention, a vector reduce instruction is provided that reduces data of a vector while representing or summarizing the data. This improves processing within a computer. As one example, the data of the vector is result data from, for instance, another instruction, such as a compare instruction (e.g., a vector compare instruction) in which for a true compare, a field is filled with all 1's (e.g., binary 1's), as an example, and for a false compare, a field is filled with all 0's (e.g., binary 0's), as an example. By reducing the field to, e.g., one 1 (e.g., binary 1) or one 0 (e.g., binary 0), a target result (e.g., target operand in a register, such as, e.g., a general purpose register, vector register, etc.) may hold results for a number of fields. As an example, a general purpose register (or other register) having a smaller size than, e.g., the source vector register may store a representation of the results stored in the source vector register. This facilitates further processing that is to use those results.

In one example, further instructions and/or processing that use the reduced data are facilitated by reducing the amount of data to be processed, thereby accelerating response times and performance. Further, processing is improved by performing the reduction in register(s) without memory access. The use of such an instruction to reduce the data to be used by other processes significantly reduces, in one or more embodiments, the number of instructions to be executed by the further processing.

The reduced data may be used by any number of processes and/or instructions. In one example, the reduced data is used to facilitate and improve processing of decision trees, which may be part of machine learning, in one or more embodiments. Decision trees may be used for classification tasks, as an example, such as in detecting misuse of information, etc. Decision nodes of a decision tree process by comparing input data to constants. This is developed during the training step of a decision node building project in which a machine learning model is developed. The compares are done in parallel through instructions utilizing, e.g., vector registers. The results of the compares are field-wide true/false (e.g., binary I/O) values stored in a result vector. These field-wide values are then reduced, in accordance with one or more aspects of the present invention, to single bit indicators, as an example, and placed at appropriate offsets in a result location. For instance, decision tree and model training are performed, external to the reduce data processing, producing a trained model, which is converted to a callable module that invokes, e.g., a vector reduce instruction. Based on completing the result vector, leaf nodes of the decision tree are processed.

By using one or more aspects of the invention, decision trees are processed faster, and memory access is reduced providing less pipeline stalls. In one example, decision nodes of a decision tree map to the bits in the result vector, which is then processed using a vector reduce instruction to simplify the results in the result vector. By using this processing, decision trees are processed faster, providing benefits to those environments, including computing environments, using decision trees. In one or more embodiments, the use of the vector reduce instruction eliminates a code path of many instructions on decision nodes and many instructions on leaf nodes.

Although one example of using vector reduce processing (e.g., a vector reduce instruction, such as Vector Reduce instruction 400) for decision tree processing is provided, vector reduce processing may be used in any processing in which a logic sequence of a plurality of bits can be reduced to a single bit (or a set of bits less than the plurality of bits). In one or more aspects, an instruction is provided that processes a set of fields (elements) independently of each other within a single vector (e.g., a single vector register). The instruction executes, for instance, horizontal logic against the bits of each field (or selected fields) and reduces the content to, e.g., a single bit. A result of processing the one or more fields is a concatenation of the one or more result bits. A reduction of the set of fields in a vector register to a same number (of the number of fields) of concatenated bits in a result register, in one embodiment, enables subsequent processing to run in parallel. For instance, subsequent processing for a decision tree may run in parallel.

In one or more aspects, reducing the set of fields in a vector register to a set of bits in a target register enables subsequent logic operations to be performed in registers without having to access main memory (e.g., random access memory). This improves processing speed since accessing registers is faster than accessing memory.

Described herein is one example of a vector reduce instruction used to reduce source data providing reduced target data. The vector reduce instruction provides a one-step process to set correct bits in a target location (e.g., a result field, a result vector, etc.) to be used by other processing. This reduces a significant instruction path for updating the target location, reducing the number of instructions to be used to update the target location.

Although various examples are provided for one or more formats of the instruction, additional and/or other formats may be used. Further, the processing may be used for other purposes than described herein.

Other variations and embodiments are possible.

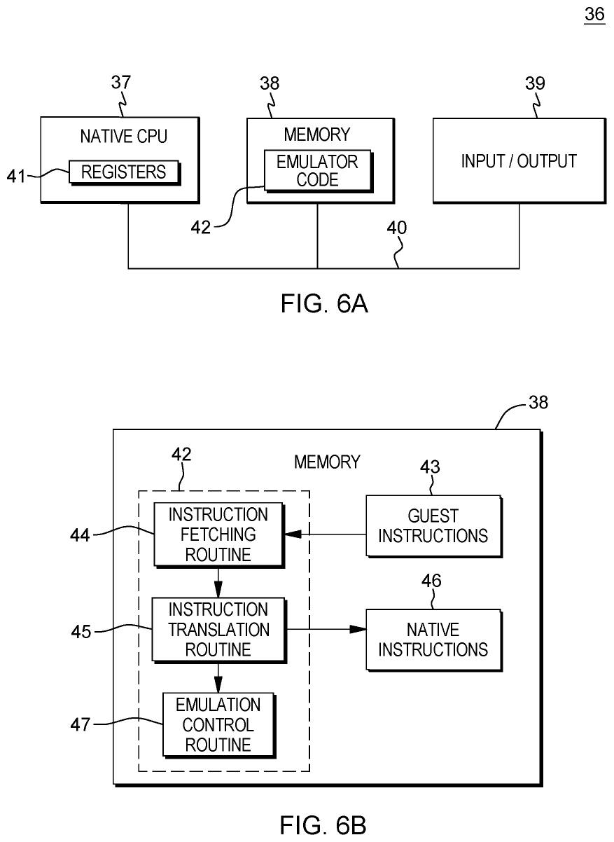

Further, although one or more examples of a computing environment to incorporate and use one or more aspects of the present invention are described herein, FIGS. 6A-6B depict another embodiment of a computing environment to incorporate and use one or more aspects of the present invention.

Referring, initially, to FIG. 6A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 6B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native CPU 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

An example instruction that may be emulated is the Vector Reduce instruction described herein, in accordance with one or more aspects of the present invention.

The computing environments described herein are only examples of computing environments that can be used. One or more aspects of the present invention may be used with many types of environments. The computing environments provided herein are only examples. Each computing environment is capable of being configured to include one or more aspects of the present invention. For instance, each may be configured to implement vector reduce processing and/or to perform one or more other aspects of the present invention.

One or more aspects of the present invention are tied to computer technology and facilitate processing within a computer, improving performance thereof. For instance, processing speed is increased, and storage requirements and costs are reduced. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other instruction formats, operands and/or registers may be used. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer readable storage media and program instructions collectively stored on the one or more computer readable storage media to perform a method comprising:
obtaining an instruction to be executed within the computing environment, the instruction including an operation code indicating a reduce instruction; and
executing the instruction, the executing including:
selecting a field of a source operand stored in a source location, the source location designated using the instruction and the field including a plurality of bits;
performing an operation on the plurality of bits of the field to obtain a result, the result reducing the plurality of bits to a set of bits, the set of bits comprising one or more bits and having fewer bits than the plurality of bits; and
placing the result in a target location, the target location specified using the instruction.

2. The computer program product of claim 1, wherein the set of bits includes one bit.

3. The computer program product of claim 1, wherein the operation is a logical operation applied horizontally across the field proceeding one bit at a time, and wherein the result is one bit resulting from applying the logical operation to the plurality of bits of the field.

4. The computer program product of claim 1, wherein the operation is a logical AND operation.

5. The computer program product of claim 1, wherein the operation is selected from a group of operations consisting of a logical AND, a logical OR, a logical exclusive OR, a logical Not AND, a logical Not OR, and a logical Not exclusive OR.

6. The computer program product of claim 1, wherein the source location is a register, and the target location is another register.

7. The computer program product of claim 1, wherein the source location is a vector register and the source operand is a vector including a plurality of fields.

8. The computer program product of claim 1, wherein the instruction provides an indication of an offset, and wherein the placing the result in the target location includes using the offset to place the result in the target location.

9. The computer program product of claim 1, wherein the source operand includes a plurality of fields of data to be reduced, and wherein the selecting, performing and placing are performed for each of the fields of the plurality of fields of data to be reduced.

10. The computer program product of claim 1, wherein the instruction includes a source instruction field and an extension instruction field to be used to specify the source location, a target instruction field to be used to specify the target location, a mask field to be used to specify a size of the field of the source operand, an operation instruction field to be used to specify the operation to be performed, and an offset instruction field to be used to specify an offset into the target location.

11. A computer system for facilitating processing within a computing environment, the computer system comprising:
a memory; and
a processor in communication with the memory, wherein the computer system is configured to perform a method, said method comprising:
obtaining an instruction to be executed within the computing environment, the instruction including an operation code indicating a reduce instruction; and
executing the instruction, the executing including:
selecting a field of a source operand stored in a source location, the source location designated using the instruction and the field including a plurality of bits;
performing an operation on the plurality of bits of the field to obtain a result, the result reducing the plurality of bits to a set of bits, the set of bits comprising one or more bits and having fewer bits than the plurality of bits; and
placing the result in a target location, the target location specified using the instruction.

12. The computer system of claim 11, wherein the set of bits includes one bit.

13. The computer system of claim 11, wherein the operation is a logical operation applied horizontally across the field proceeding one bit at a time, and wherein the result is one bit resulting from applying the logical operation to the plurality of bits of the field.

14. The computer system of claim 11, wherein the instruction provides an indication of an offset, and wherein the placing the result in the target location includes using the offset to place the result in the target location.

15. The computer system of claim 11, wherein the instruction includes a source instruction field and an extension instruction field to be used to specify the source location, a target instruction field to be used to specify the target location, a mask field to be used to specify a size of the field of the source operand, an operation instruction field to be used to specify the operation to be performed, and an offset instruction field to be used to specify an offset into the target location.

16. A computer-implemented method of facilitating processing within a computing environment, the computer-implemented method comprising:
obtaining an instruction to be executed within the computing environment, the instruction including an operation code indicating a reduce instruction; and
executing the instruction, the executing including:
selecting a field of a source operand stored in a source location, the source location designated using the instruction and the field including a plurality of bits;
performing an operation on the plurality of bits of the field to obtain a result, the result reducing the plurality of bits to a set of bits, the set of bits comprising one or more bits and having fewer bits than the plurality of bits; and
placing the result in a target location, the target location specified using the instruction.

17. The computer-implemented method of claim 16, wherein the set of bits includes one bit.

18. The computer-implemented method of claim 16, wherein the operation is a logical operation applied horizontally across the field proceeding one bit at a time, and wherein the result is one bit resulting from applying the logical operation to the plurality of bits of the field.

19. The computer-implemented method of claim 16, wherein the instruction provides an indication of an offset, and wherein the placing the result in the target location includes using the offset to place the result in the target location.

20. The computer-implemented method of claim 16, wherein the instruction includes a source instruction field and an extension instruction field to be used to specify the source location, a target instruction field to be used to specify the target location, a mask field to be used to specify a size of the field of the source operand, an operation instruction field to be used to specify the operation to be performed, and an offset instruction field to be used to specify an offset into the target location.
